(19) United States
(12) Patent Application Publication
(10) Pub. No.: US 2021/0409487 A1
(43) Pub. Date: Dec. 30, 2021

(54) APPARATUS AND METHOD FOR CONTROLLING DATA TRANSMISSION IN NETWORK SYSTEM

(71) Applicant: ALIBABA GROUP HOLDING LIMITED, George Town, Grand Cayman (KY)

(72) Inventors: Jianwen PI, San Jose, CA (US); Shuai SHANG, Hangzhou (CN); Yuke HONG, Hangzhou (CN); Haiyong WANG, Bellevue, WA (US)

(21) Appl. No.: 16/765,751

(22) PCT Filed: Jul. 30, 2019
(86) PCT No.: PCT/CN2019/098397

§ 371 Date: May 20, 2020

(51) Int. Cl. H04L 29/08

(52) U.S. Cl. CPC H04L 67/1004

(57) ABSTRACT

The present disclosure provides an apparatus for controlling data transmission in a network system. The apparatus includes a programmable chip configured to forward data in the network system, one or more storage devices configured to store a set of instructions, and one or more processors configured to execute the set of instructions to cause the apparatus to: control, via a first interface, the programmable chip to provide a switching function at a data link layer or a network layer; and control, via a second interface, the programmable chip to provide a layer 4 to layer 7 networking service.

### TECHNICAL FIELD

The present disclosure relates to network systems, and in particular, to apparatuses and methods for controlling data transmission in the network systems.

### BACKGROUND

In cloud computing technologies, numerous types of cloud computing services, including Infrastructure as a Service (IaaS), Software as a Service (SaaS), and/or Platform as a Service (PaaS), are provided. A user can access cloud-based applications hosted by application service providers in data centers, over a packet switched network, which is a backbone of the data communication infrastructure.

However, in traditional architecture, packet switching and forwarding in the network is usually achieved by fixed-function switches. Functionalities and capabilities of the switches are dictated by switch vendors and not by network operators. Accordingly, these switches provide limited flexibility in response to operator's changing requirements. In addition, software development is limited by the specific protocol formats supported by the vendor, which causes high investments and costs in developing software across different hardware platforms.

### SUMMARY

The present disclosure provides an apparatus for controlling data transmission in a network system. The apparatus includes a programmable chip configured to forward data in the network system, one or more storage devices configured to store a set of instructions, and one or more processors configured to execute the set of instructions to cause the apparatus to: control, via a first interface, the programmable chip to provide a switching function at a data link layer or a network layer; and control, via a second interface, the programmable chip to provide a layer 4 to layer 7 networking service.

The present disclosure provides a method for controlling data transmission in a network system. The method includes: controlling, via a first interface, a programmable chip to provide a switching function at a data link layer or a network layer; and controlling, via a second interface, the programmable chip to provide a layer 4 to layer 7 networking service.

The present disclosure provides a non-transitory computer-readable medium that stores a set of instructions that is executable by one or more processors of an apparatus to cause the apparatus to perform a method for controlling data transmission in a network system. The method for controlling data transmission in the network system includes: controlling, via a first interface, a programmable chip to provide a switching function at a data link layer or a network layer; and controlling, via a second interface, the programmable chip to provide a layer 4 to layer 7 networking service.

The present disclosure provides a controller. The controller includes one or more storage devices configured to store a set of instructions, and one or more processors configured to execute the set of instructions to cause the controller to: control, via a first interface, a programmable chip to provide a switching function at a data link layer or a network layer; and control, via a second interface, the programmable chip to provide a layer 4 to layer 7 networking service.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an exemplary network system, consistent with embodiments of the present disclosure.

FIG. 2 is a schematic diagram illustrating an exemplary networking architecture of the network system shown in FIG. 1, consistent with embodiments of the present disclosure.

FIG. 3 is a schematic diagram illustrating an exemplary host system running in a network appliance, consistent with embodiments of the present disclosure.

FIG. 4 is a schematic diagram illustrating an exemplary data flow in the network appliance of FIG. 3 to process packets, consistent with embodiments of the present disclosure

FIG. 5 is a schematic diagram illustrating loading a service runtime application programming interface (API) into a host system and loading binary codes to a program programmable chip, consistent with embodiments of the present disclosure.

FIG. 6 is a schematic diagram illustrating an exemplary programmable chip, consistent with embodiments of the present disclosure.

FIG. 7A is a schematic diagram illustrating an exemplary packet processing in a pipeline, consistent with embodiments of the present disclosure.

FIG. 7B is a schematic diagram illustrating an exemplary packet processing in a pipeline, consistent with embodiments of the present disclosure.

FIG. 8 is a schematic diagram illustrating exemplary packets processing and forwarding through pipelines in a program programmable chip, consistent with embodiments of the present disclosure.

FIG. 9 is a flow diagram of an exemplary method for controlling data transmission in a network system, consistent with embodiments of the present disclosure.

### DETAILED DESCRIPTION

The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Embodiments of the present disclosure mitigate the problems stated above by providing apparatuses and methods for controlling data transmission in a network system. In various embodiments, an interface, such as a service runtime application programming interface (API), and a service code for programming a programmable chip are generated in accordance with a service model. The programmable chip is programmed to provide, under the control of a host Central Processing Unit (CPU), both switching functions at layer 2 (i.e., the data link layer) or layer 3 (i.e., the network layer) of the Open Systems Interconnection (OSI) model, and networking service(s) in layer 4 to layer 7 (i.e., the transport layer, the session layer, the presentation layer, and the application layer, respectively) of the OSI model. The programmable chip may be configured to serialize pipelines for layer 4 to layer 7 (L4-L7) networking service(s) and pipelines for layer 2 or layer 3 (L2 or L3) switching functions.

In a host system running in the host CPU, applications associated with the L2 or L3 switching functions communicate with the programmable chip via a network operating system built on an interface that is different from the service runtime API, such as a hardware abstraction layer (e.g., a switch abstraction interface). Applications associated with the L4-L7 networking service(s) communicate with the programmable chip via the service runtime API generated in accordance with the service model describing the L4-L7 networking service(s).

Accordingly, shortcomings of the current switching technology can be overcome by embodiments of the present disclosure. With the apparatuses and the methods disclosed in various embodiments, the L4-L7 networking service(s) can be performed in the programmable chip without interfering the fixed switching function. Thus, various network systems, including content delivery network (CDN) and edge computing, can benefit from this combined framework.

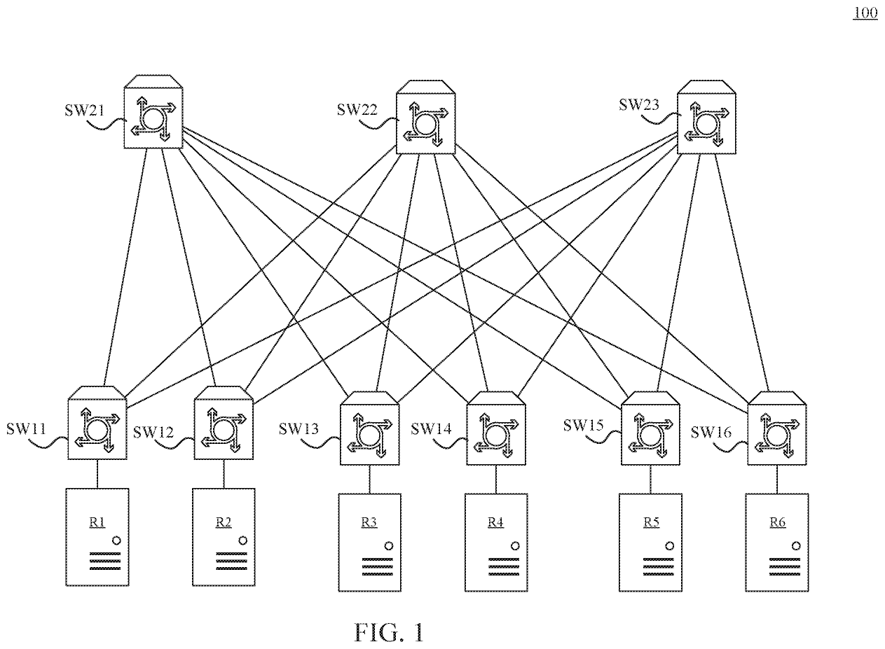

Reference is made to FIG. 1, which is a schematic diagram illustrating an exemplary network system 100, consistent with embodiments of the present disclosure. Network system 100 can be a network of data centers, edge computing systems, or cloud computing systems. As shown in FIG. 1, network system 100 can include multiple servers arranged in multiple racks, e.g., racks R1-R6 (i.e., R1, R2, . . . , and R6). Servers in racks R1-R6 are connected to Top-of-Rack switches SW11-SW16 (i.e., SW11, SW12, . . . , and SW16) respectively. In some embodiments, network system 100 can apply a leaf-spine architecture, in which Top-of-Rack switches SW11-SW16 are leaf switches, and fully meshed to spine switches SW21-SW23 (i.e., SW21, SW22, and SW23). It is noted that the network topology illustrated in FIG. 1 is merely an example and not meant to limit the present disclosure. In various embodiments, different architectures or topologies may be applied in network system 100 to build the network of servers in data centers in order to transmit data between servers and perform various applications, such as traffic accounting, workload analysis, scheduling, load balancing, firewall, and/or other security services.

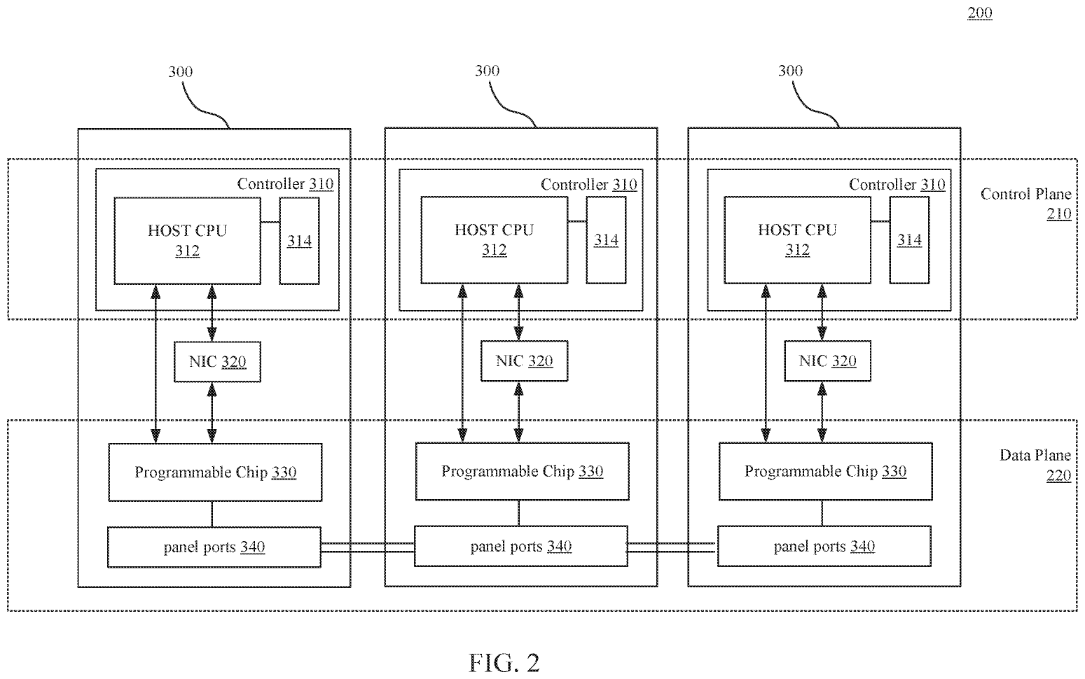

Reference is made to FIG. 2, which is a schematic diagram illustrating an exemplary networking architecture 200 of network system 100, consistent with embodiments of the present disclosure. The switching function of Top-of-Rack switches SW11-SW16 and spine switches SW21-SW23 illustrated in network system 100 of FIG. 1 can be achieved by deploying multiple network appliances 300. Network appliances 300 are apparatuses for controlling data transmission in network system 100. Each network appliance 300 can include a controller 310 including host CPU 312 and a host memory 314, a Network Interface Controller (NIC) 320, a programmable chip 330, and a plurality of ports 340 for traffic ingress or egress. Host memory 314 is connected to and associated with host CPU 312 in a control plane 210. Programmable chip 330 is in a data plane 220, also known as a forwarding plane, and configured to forward data in network system 100.

Control plane 210 can determine destinations of packets in a data traffic by generating one or more matching tables, which include switching/routing information for the packets. That is, the one or more matching tables contain information to identify where the packets should be sent. The one or more matching tables can be passed down to programmable chip 330 in data plane 220. Therefore, data plane 220 can forward the packets to a next hop along the path determined according to the matching tables, to selected destinations respectively. Control plane 210 can also update or remove the one or more matching tables stored in the programmable chip 330, so as to generate new policies of the data traffic.

Host memory 314 includes one or more storage devices configured to store a set of instructions. Host CPU 312 includes one or more processors configured to execute the set of instructions stored in host memory 314 to cause network appliance 300 to perform operations for controlling data transmission in network system 100. NIC 320, as an interface layer between control plane 210 and data plane 220, is configured to provide a channel to transmit data between programmable chip 330 and host CPU 312. In some embodiments, data may also be transmitted between programmable chip 330 and host CPU 312 via other proper interfaces, such as a Peripheral Component Interconnect Express (PCI-E) interface.

Programmable chip 330, also referred to as switching silicon, can be a programmable application-specific integrated circuit (programmable ASIC) or a field programmable gate array (FPGA). Each of ports 340 connects to one of multiple pipelines in programmable chip 330, such that packets transmitted in the network can be processed and forwarded by programmable chip 330 with or without the assistance of host CPU 312. In some embodiments, ports 340 can run in different speeds, such as 100 GbE, 50 GbE, 40 GbE, 25 GbE, 10 GbE, or any other possible values.

For example, when an ingress packet is sent to network appliance 300 via one of ports 340, the ingress packet can be processed by programmable chip 330 first. If there is a matching route for the ingress packet in the matching tables, programmable chip 330 can directly forward the ingress packet to the next hop according to the matching route. The above process can be performed in a relatively short time, and therefore, data plane 220 can also be referred to as a fast path. If no matching route can be found in the matching tables, the ingress packet can be considered as the first packet for a new route. In this condition, the ingress packet is sent to host CPU 312 via NIC 320 for further processing. That is, in some embodiments, control plane 210 can be only invoked when matching route for the ingress packet is missing in data plane 220. As described above, host CPU 312 can then determine where the packet should be sent and cause programmable chip 330 to update the matching tables accordingly. For example, host CPU 312 can instruct programmable chip 330 to add information of the new route to the matching tables. Alternatively, host CPU 312 can generate a new matching table including the information of the new route, and pass down the new table to programmable chip 330. Therefore, subsequent packet(s) in this flow route can be handled by programmable chip 330 based on the updated matching tables. The above process of control plane 210 usually takes more time compared to the process of data plane 220, and thus control plane 210 is sometimes referred to as a slow path. For the ease of understanding, detailed operations of programmable chip 330 will be discussed in further detail below in conjunction with accompanying figures.

In some embodiments, network appliance 300 may include other components to support operations of network appliance 300. For example, network appliance 300 may include a baseboard management controller (BMC), a fan board including one or more fan modules configured to cool network appliance 300, a power converter module for supplying power required by network appliance 300, and one or more bus interfaces to connect the components in network appliance 300. For example, the BMC, the fan board, and the power converter module may be connected to host CPU 312 via an Inter-Integrated Circuit bus (I²C bus).

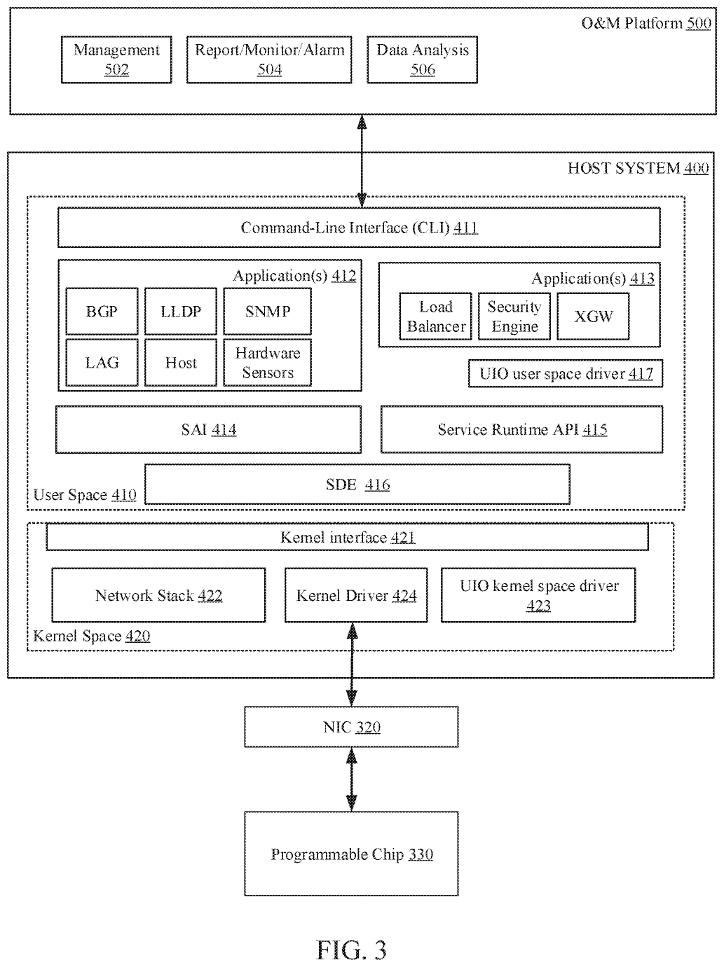

Reference is made to FIG. 3, which is a schematic diagram illustrating an exemplary host system 400 running in network appliance 300, consistent with embodiments of the present disclosure. Modules and components in host system 400 can be software codes stored in the one or more storage devices in host memory 314, and executed by one or more hardware processors in host CPU 312, to provide corresponding functions or environments. As shown in FIG. 3, host system 400 can include a user space 410 and a kernel space 420. User space 410 runs processes having limited accesses to resources provided by host system 400. For example, host system 400 can be configured to provide various cloud computing services and processes can be established in user space 410 to provide computation to users of the cloud services. More particularly, one or more of a Command Line Interface (CLI) 411, application(s) 412, application(s) 413, a Switch Abstraction Interface (SAI) 414, a service runtime API 415, a Software Development Environment (SDE) 416, and a user space Input/Output user space driver (UIO user space driver) 417 can be deployed in user space 410.

Host system 400 is configured to receive commands from an Operations and Maintenance (O&M) platform 500. O&M platform 500 can provide various software tools, including a management module 510, a monitoring and report module 520 which provides tools for monitoring, reporting and alarms, and a data analysis module 530. Accordingly, operators can manage and monitor the cloud services, such as software as a service (SaaS) applications, via O&M platform 500. Host system 400 can communicate with O&M platform 500 over command-line interface (CLI) 411 using a Representational State Transfer (REST) architectural style API (e.g., RESTful API), and accordingly perform various tasks, such as installing or updating configuration files and installing or updating one or more databases in host system 400.

Application(s) 412 are configured to offer L2 or L3 switching functions, and application(s) 413 are configured to offer the L4-L7 networking service(s). More particularly, application(s) 412, running on a network operating system (NOS) built on a first interface, such as switch abstraction interface (SAI) 414, can control programmable chip 330 to provide fixed switching functions. SAI 414 is a hardware abstraction layer and defines a standardized API to provide a consistent programming interface to various programmable chips 330 supplied from different network hardware vendors. That is, application(s) 412 running on the NOS are decoupled from programmable chip 330 and thus are able to support multiple hardware platforms provided by different programmable chip vendors. Accordingly, SAI 414 enables operators to take advantage of the rapid development in silicon, CPU, power, port density, optics, and speed, while preserving their investment in one unified software solution across multiple platforms.

For example, Software for Open Networking in the Cloud (SONiC), an open source NOS, is a platform which can be built on SAI 414. SAI 414 allows different ASICs or FPGAs to run SONiC with their own internal implementation. SONiC can provide various docker-based services for managing and controlling packets processing, and support network applications and protocols such as Link Layer Discovery Protocol (LLDP), Simple Network Management Protocol (SNMP), Link Aggregation Group (LAG), Border Gateway Protocol (BGP), Dynamic Host Configuration Protocol (DHCP), Internet Protocol version 6 (IPv6), etc.

In some embodiments, the NOS can also support drivers for hardware sensors or other device-specific hardware required in network appliance 300. These hardware sensors may be used to monitor temperatures, fan speeds, voltages, etc., for generating alarms at corresponding thresholds to alert an abnormal operation status of network appliance 300. Application(s) 412, SAI 414, and SONiC built on SAI 414 can provide the management and control of fixed switch functions in programmable chip 330, and also provide tools and environment for operators to operate and maintain network system 100 via O&M platform 500.

In addition, host system 400 can also run application(s) 413 which provide other extended networking functions. For example, while application(s) 412 provide switching functions at L2 or L3 of the OSI model, application(s) 413 may provide networking service(s) in L4-L7 of the OSI model, such as load balancers, security functions including firewalls, Uniform Resource Locator (URL) filtering, Distributed Denial of Service (DDoS) attack protections, or other networking services which can be used in data centers, edge computing systems, or cloud computing systems. Application(s) 413 can access, manipulate and respond to data in host CPU 312 or in programmable chip 330 using a second interface, such as service runtime API 415, loaded in user space 410. Application(s) 413 and service runtime API 415 provide a high-performance environment to run self-developed L4-L7 networking functions in either host CPU 312 or programmable chip 330.

In some embodiments, SDE 416 includes an ASIC SDE or FPGA SDE to support programmable chip 330. SDE 416 provides tools, such as compilers, models, applications, abstraction APIs, debugging and visibility tools, drivers, etc., for developers to build efficient and scalable network systems. SDE 416 can be used to simplify the development, debugging and optimization of applications 412, 413 for integration with the network operating system.

Kernel space 420 of host system 400 can run codes in a “kernel mode.” These codes can also be referred to as the “kernel,” which is a core part of host system 400. A kernel interface 421, a kernel network stack 422, a user space Input/Output kernel driver (UIO kernel driver) 423 and a kernel driver 424 can be deployed in kernel space 420.

In some embodiments, kernel interface 421 includes a system call interface to handle communication between user space 410 and kernel space 420. Kernel network stack 422 includes a Transmission Control Protocol/Internet Protocol stack (TCP/IP stack) for switching and routing operations. UIO kernel space driver 423 is configured to setup UIO framework and run as a layer under UIO user space driver 417 deployed in user space 410. This UIO framework can be provided to improve performance in networking, since some tasks can be accomplished in UIO user space driver 417. Device access can be efficient as there is no system call required in the UIO framework. Accordingly, communication tasks between host system 400 and programmable chip 330 via NIC 320 can be handled by these components in kernel space 420. For example, kernel driver 424 in kernel space 420 can write data (e.g., configuration information generated by application(s) 412, 413 in user space 410) into programmable chip 330 via NIC 320 or other interfaces connecting Host CPU 312 and programmable chip 330.

Various forms of media can be involved in carrying one or more sequences of one or more instructions to the processor(s) for execution. For example, the instructions can initially be carried out on a magnetic disk or solid-state drive of a remote computer. The remote computer can load the instructions into its dynamic memory and send the instructions over a telephone line using a modem. A modem local to network appliance 300 can receive the data on the telephone line and use an infra-red transmitter to convert the data to an infra-red signal. An infra-red detector can receive the data carried in the infra-red signal and appropriate circuitry can place the data on a bus, which carries the data to a main memory within the storage device(s), from which processor(s) retrieve and execute the instructions.

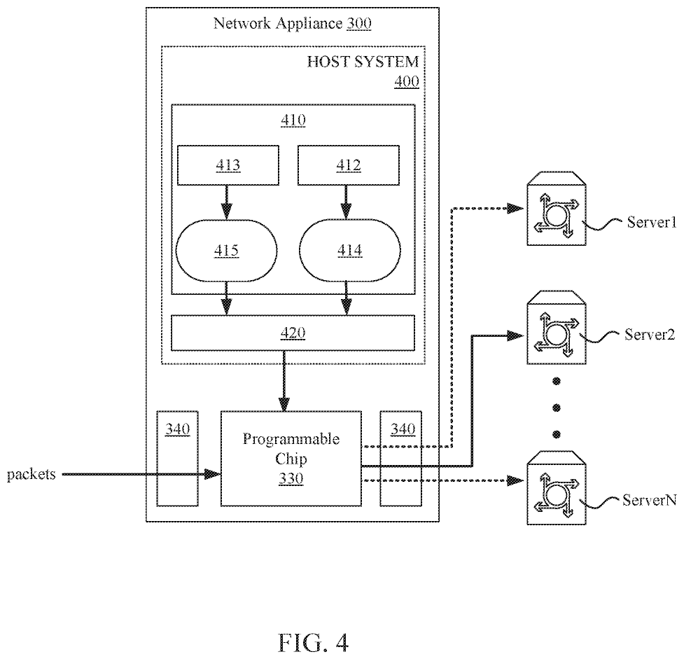

For further understanding of operations in host system 400, reference is made to FIG. 4, which is a schematic diagram illustrating an exemplary data flow in network appliance 300 to process packets, consistent with embodiments of the present disclosure. As shown in FIG. 4, for the switching functions provided by applications 412, configuration information (e.g., matching tables) generated by applications 412 can be processed and loaded into programmable chip 330 via switch abstraction interface 414, so that programmable chip 330 can process and forward the packets properly. On the other hand, for the extended networking service(s) provided by applications 413, configuration information (e.g., matching tables) generated by applications 413 can be processed and loaded into programmable chip 330 via the loaded service runtime API 415, so that programmable chip 330 can process and forward target packets properly to perform the extended networking service(s).

For example, the extended networking service(s) may include a load balancer at the fourth layer of the OSI model. After the load balancer receives a connection request, it selects a target (e.g., front-end server Server2) from a group of candidates (e.g., front-end servers Server1, Server2, . . . , and ServerN), and opens a connection to the selected target to forward the packets. Accordingly, incoming traffic can be distributed across multiple target servers, which increases the availability of applications.

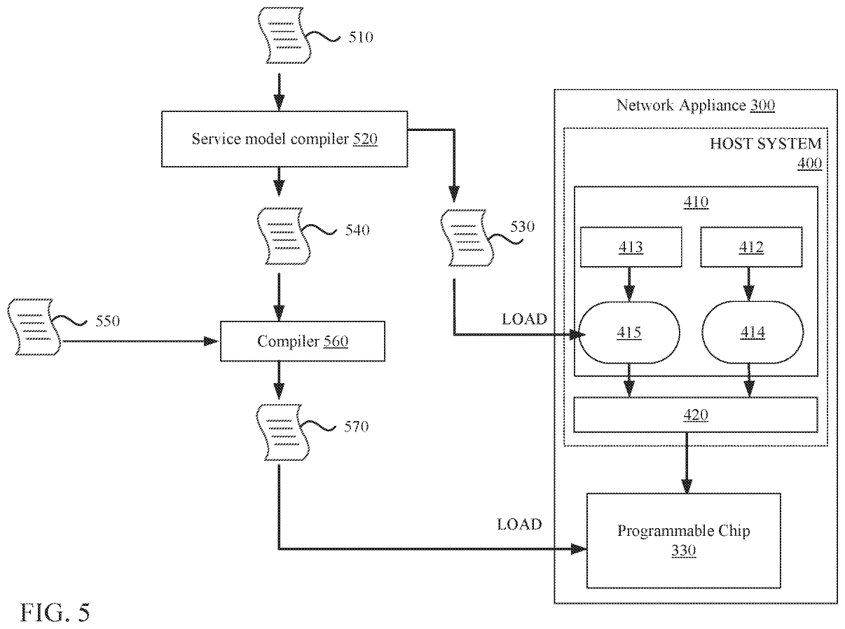

FIG. 5 is a diagram illustrating a process of loading service runtime API 415 into host system 400 and loading binary codes into program programmable chip 330 to perform the networking service(s) described above, consistent with embodiments of the present disclosure. As shown in FIG. 5, an extended networking service can be described in a service model 510. Service model 510 specifies functionalities of the extended networking service(s) and hooks where each functionality should be executed in programmable chip 330 using a service model language.

Service model compiler 520 is configured to load service model 510 and generate a service runtime API 530 and a service code 540 in accordance with service model 510. More particularly, service model compiler 520 can identify programmable chip 330, and compile service model 510 to generate service runtime API 530 and service code 540 in response to an identification of a programmable chip 330. Alternatively stated, the generated service runtime API 530 and service code 540 are platform dependent and corresponding to programmable chip 330, in order to support the platform and hardware of programmable chip 330. In some embodiments, service model compiler 520 can generate corresponding service codes 540 in different programming languages to support different hardware platforms. For example, service code 540 can be written in a domain-specific language, such as Programming Protocol-Independent Packet Processors (P4) language which includes a number of constructs optimized around network data forwarding. Thus, developers can define and develop the extended networking service using a service model description language to provide service model 540, and service model compiler 520 can generate different service runtime APIs 530 and service codes 540 for programmable chips 330 supplied from multi-vendors.

The platform-dependent service code 540 is fed into a compiler 560 in accompanying with a fixed function code 550 for the fixed switching functions, such as a layer 2 or a layer 3 switching. Fixed function code 550 can be written in the same programming language as service code 540. Thus, the platform-dependent compiler 560 (e.g., a P4 compiler) is able to compile service code 540 with fixed function code 550, and generate an executable code 570 in accordance with service code 540 and fixed function code 550.

In some embodiments, executable code 570 may be a target specific configuration binary code to be loaded into network appliance 300. Accordingly, programmable chip 330 can be programmed using executable code 570 compiled in accordance with service code 540 and fixed function code 550, to provide both the fixed switching functions and the extended networking service(s) under the control of host system 400. Thus, host system 400 can control, via switch abstraction interface 412, programmable chip 330 to provide switching functions at a data link layer (i.e., layer 2) or a network layer (i.e., layer 3) of the OSI model, and control, via service runtime API 414, programmable chip 330 to provide one or more networking services in L4-L7 of the OSI model.

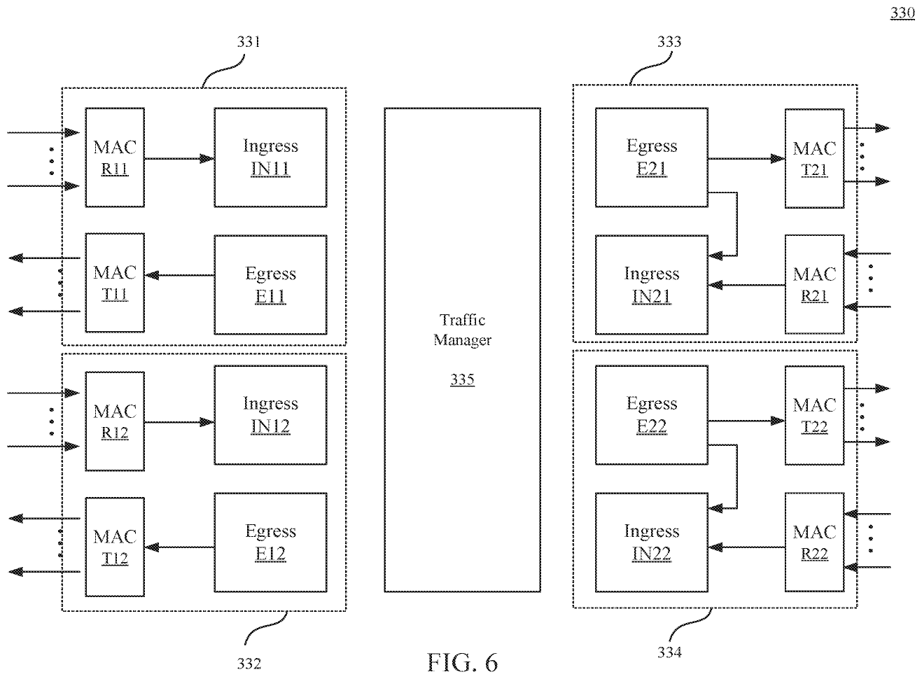

Reference is made to FIG. 6, which is a schematic diagram illustrating an exemplary programmable chip 330, consistent with embodiments of the present disclosure. In some embodiments, programmable chip 330 includes one or more pipelines (e.g., pipelines 331, 332, 333, 334) and a traffic manager 335 with a shared packet buffer. Each of the pipelines 331, 332, 333, 334 is shared by a number of ports where the traffic ingress or egress. In some embodiments, the shared packet buffer can be dynamically shared across ports of pipelines 331, 332, 333, 334 in programmable chip 330. Pipelines 331, 332, 333, 334 include receive Media Access Controls (receive MACs) R11, R12, R21, R22, ingress pipelines IN11, IN12, IN21, IN22, transmit Media Access Controls (transmit MACs) T11, T12, T21, T22, and egress pipelines E11, E12, E21, E22.

Packets arriving at receive MACs R11, R12, R21, R22 are processed by corresponding ingress pipelines IN11, IN12, IN21, IN22, and then enqueued in the shared packet buffer which connects ingress and egress ports. On being scheduled for transmission, packets are passed through egress pipelines E11, E12, E21, E22 to the transmit MACs T11, T12, T21, T22.

In some embodiments, each of the pipelines 331, 332 has ingress ports configured to receive data from corresponding ports 340 of network appliance 300, and egress ports configured to forward data to corresponding ports 340 of network appliance 300. On the other hand, each of the pipelines 333, 334 has ingress ports and egress ports, in which the ingress ports are configured to receive data from the corresponding egress ports. That is, pipelines 333, 334 form internal loopbacks without exposing to ports 340 of network appliance 300, and packets are recirculated from egress pipelines E21, E22 to corresponding ingress pipelines IN21, IN22.

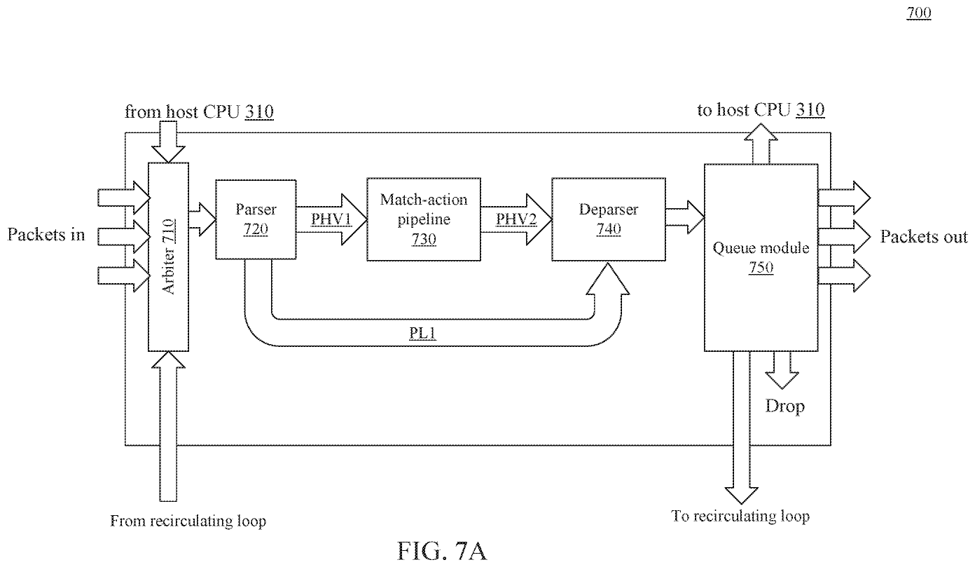

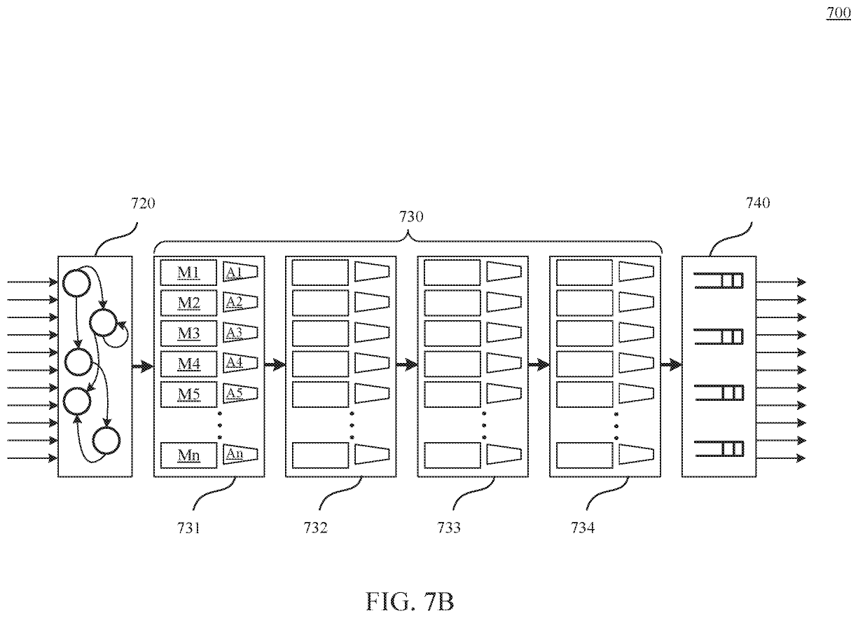

FIG. 7A and FIG. 7B are schematic diagrams illustrating an exemplary packet processing in a pipeline 700, consistent with embodiments of the present disclosure. Any one of ingress pipelines IN11, IN12, IN21, IN22 and egress pipelines E11, E12, E21, E22 illustrated in FIG. 6 may have the same or similar components in pipeline 700. Pipeline 700 includes an arbiter 710, a parser 720, a match-action pipeline 730, a deparser 740, and a queue module 750.

Referring to FIG. 7A, in some embodiments, arbiter 710 selects a packet from pending packets based on priorities of input channels and sends out the selected packet to parser 720. Packets may be received from ports 340, from host CPU 312 via NIC 320, or recirculated from one of egress pipelines (e.g., egress pipelines E21, E22). Parser 720 is configured to analyze incoming packets and map the packets to corresponding set of fields called Packet Header Vectors (PHVs) PHV1, which carry the headers and metadata along pipeline 700. Alternatively stated, parser 720 separates the packet headers from packet payload PL1 by extracting different fields of packet headers and storing these fields in PHV PHV1.

In some embodiments, PHV PHV1 includes a set of different size registers or containers. For example, PHV PHV1 may include sixty-four 8-bit registers, ninety-six 16-bit registers, and sixty-four 32-bit registers (for a total of 224 registers containing 4096 bits), but the present disclosure is not limited thereto. In various embodiments, PHV PHV1 may have any different numbers of registers of different sizes. Parser 720 may store each extracted packet header in a particular subset of one or more registers of PHV PHV1. For example, the parser may store a first header field in one 16-bit register and store a second header field in a combination of an 8-bit register and a 32-bit register, if a length (e.g., 40-bit) of the second header field exceeds than the length of a single register.

PHVs PHV1 are then passed through match-action pipeline 730. As shown in FIG. 7B, in some embodiments, match-action pipeline 730 can include a set of MAUs 731, 732, 733, 734. MAUs 731, 732, 733, 734 each contain matching tables which are used to make forwarding and packet rewrite decisions. It is noted that, the illustrated match-action pipeline 730 is simplified for ease of description. In some embodiments, match-action pipeline 730 can include any numbers of match-action stages. For example, 32 MAUs may be included in match-action pipeline 730.

Still referring to FIG. 7B, in some embodiments, any one of MAUs 731, 732, 733, 734 includes one or more memory units M1-Mn configured to hold up matching tables, and one or more arithmetic logic units (ALUs) A1-An, also referred to as action units, configured to read data from the memory units. For example, memory units M1-Mn may be dedicated Static Random Access Memory (SRAM) and/or Ternary Content Addressable Memory (TCAM). Thus, MAUs 731, 732, 733, 734 can be configured to match particular sets of header fields against matching tables and take actions based on matching results. For example, possible actions may be assigning the packet to an output port and queue, dropping the packet, modifying one or more of the header fields, etc. In some embodiments, memory units M1-Mn can be arranged in a grid of rows and columns, with horizontal and vertical routing resources connecting memory units M1-Mn to ALUs A1-An, in order to perform the match and action operations.

Still referring to FIG. 7B, as PHVs are passed through MAUs 731, 732, 733, 734, keys are extracted from the set of packet fields, and the pipeline state from one matching table can also be used as the key to another matching table. In some embodiments, any one of MAUs 731, 732, 733, 734 may contain multiple matching tables to perform multiple parallel lookups to determines actions, and the actions from active tables can be combined in an action engine.

Referring to FIG. 7A, based on the actions taken on different header data during different stages in match-action pipeline 730, match-action pipeline 730 may output PHV PHV2 including the same header data as the PHV (i.e., PHV1) received from parser 720, or output a modified PHV (i.e., PHV2) including different data than the PHV (i.e., PHV1) received from parser 720. After passing through match-action pipeline 730, the outputted PHV PHV2 is then handed to deparser 740. Deparser 740 is configured to receive the outputted PHV PHV2 from match-action pipeline 730, and reassemble modified packets by putting back together the outputted PHV PHV2 and payload PL1 of the packet, which is received from parser 720. Deparser 740 then sends the packets out of pipeline 700 via queue module 750.

The packets may be sent to enqueued in the shared packet buffer and managed by traffic manager 335 for transmission, sent out of programmable chip 330 to host CPU 312 via NIC 320 or to corresponding port 340, recirculated to one of ingress pipelines (e.g., ingress pipelines IN21, IN22) or dropped, depending on the activated actions and type of the pipeline.

Accordingly, a packet outputted by pipeline 700 may be the same packet as the corresponding input packet with identical headers, or may have different headers compared to the input packet based on actions applied to the headers in pipeline 700. For example, the output packet may have different header field values for certain header fields, and/or different sets of header fields.

It is noted that illustrated components in programmable chip 330 are exemplary only. Traffic manager 335 (FIG. 6) and pipeline 700 (FIG. 7A and FIG. 7B) are simplified for ease of description. For example, in some embodiments, input packets are received by many different input channels (e.g., 64 channels) and output packets are sent out of programmable chip 330 from different output channels (e.g., 64 channels). Additionally, in some embodiments, numerous parser blocks (e.g., 16 parser blocks) can be employed in pipeline 700 to feed match-action pipeline 730.

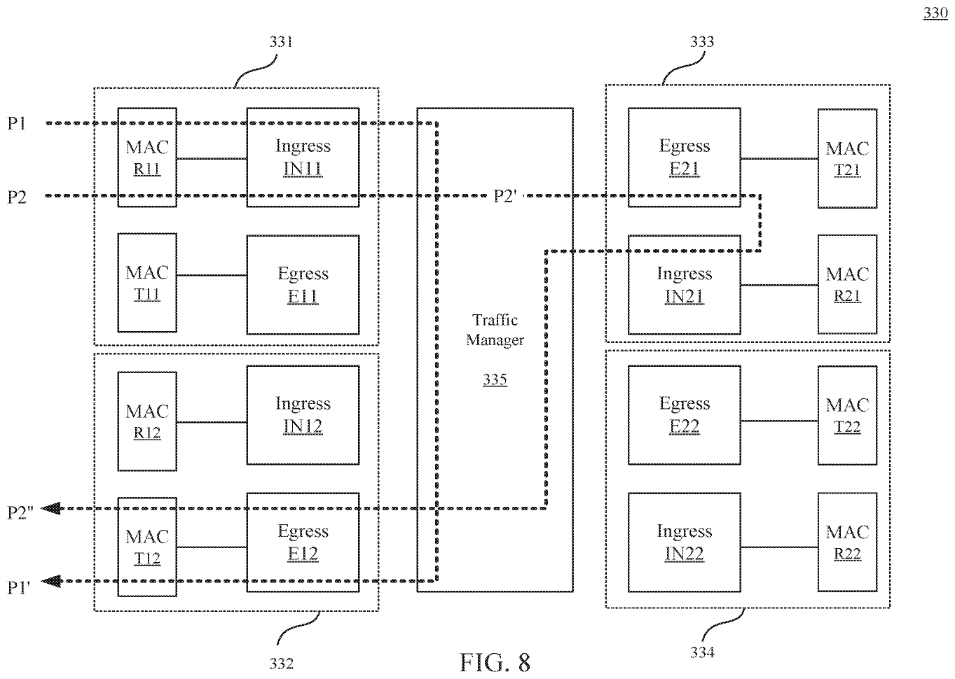

FIG. 8 is a schematic diagram illustrating a process performed by program programmable chip 330 to process and forward exemplary packets through pipelines 331, 332, 333, 334, consistent with embodiments of the present disclosure. For example, pipelines 331, 332, 333, 334 can be configured by programming programmable chip 330 using executable code 570 generated by platform-dependent compiler 560. In some embodiments, pipelines 331, 332 assigned for ports 340 of network appliance 300 can be configured to provide the switching functions at the data link layer or the network layer by configuring MAUs in pipelines 331, 332 for performing L2 and L3 operations. On the other hand, pipelines 333, 334 forming internal loopbacks can be configured to provide the L4-L7 networking service described in service model 510 by configuring MAUs in pipelines 333, 334 to execute custom codes for performing L4-L7 operations.

More particularly, service model 510 can define which packets should be processed by the L4-L7 networking service, and which pipeline the packets should be forwarded to for processing. Thus, target packets are circulated to the extra stages (e.g., egress pipelines E21, E22 and ingress pipelines IN21, IN22 in pipelines 333, 334) before being scheduled to egress pipelines E11, E12 in pipelines 331, 332.

Packet P1 in FIG. 8 is a packet to be processed by the switching functions without the extended networking service. As shown in the figure, programmable chip 330 receives packet P1 from a corresponding input port of ports 340 of network appliance 300 and passes packet P1 via a corresponding receive MAC (e. g., one of MACs R11) to a corresponding ingress pipeline (e.g., ingress pipeline IN11). Then, programmable chip 330 processes packet P1 in pipeline 311 and determines whether packet P1 is a target to be processed by the L4-L7 networking service using the MAUs. The processed packet P1 is then passed to traffic manager 335. In response to a determination that packet P1 is a packet to be processed without the L4-L7 networking service, traffic manager 335 forwards the processed packet P1′ via a corresponding egress pipeline (e.g., egress pipeline E12) and a corresponding transmit MAC (e. g., one of MACs T12) to an output port of ports 340 of network appliance 300. Thus, the switching functions at L2 or L3 can be performed by traffic manager 335 and pipelines 331, 332 assigned for ports 340 of network appliance 300, without passing through pipelines 333, 334. Accordingly, applications 412 in host system 400 can control programmable chip 330 to provide the switching functions at L2 or L3 by adding, removing, or updating corresponding matching tables in MAUs 720 in pipelines 331, 332, via SAI 414 and components in kernel space 420.

On the other hand, packet P2 in FIG. 8 is a target packet to be processed with the extended networking service. Similar to packet P1, programmable chip 330 also receives packet P2 from a corresponding input port of ports 340 of network appliance 300 and processes packet P2 in pipeline 311 and determines whether packet P2 is a target to be processed by the L4-L7 networking service using the MAUs. In response to a determination that packet P2 is a target to be processed by the L4-L7 networking service, traffic manager 335 forwards the processed packet P2′ to a corresponding pipeline (e.g., pipeline 333) with internal loopback to perform the desired L4-L7 networking service. More particularly, packet P2′ is first passed through a corresponding egress pipeline (e.g., egress pipeline E21), and then looped back via a recirculate path to a corresponding ingress pipeline (e.g., ingress pipeline IN21) in the same pipeline 333. Accordingly, programmable chip 330 processes packet P2′ in pipeline 333 for the L4-L7 networking service, such as a load balancer. After packet P2′ is processed in pipeline 333, programmable chip 330 again forward the further processed packet P2″ from pipeline 333 to pipeline 332, and then forward the processed packet P2″ to the corresponding output port of ports 340 of network appliance 300 via a corresponding egress pipeline (e.g., egress pipeline E12) and a corresponding transmit MAC (e. g., one of MACs T12).

Accordingly, applications 413 in host system 400 can control programmable chip 330 to provide the L4-L7 networking service by adding, removing, or updating corresponding matching tables in MAUs 720 in pipelines 333,334, via service runtime API 415 loaded in user space 410 and components in kernel space 420. Thus, the extended networking service(s) in L4-L7 can be further performed by circulating target packets in pipelines 333, 334 without exposing to ports 340 of network appliance 300, before scheduling target packets to egress pipelines E11, E12 in pipelines 331, 332 respectively.

In various embodiments, pipelines 333, 334 with internal loopback can be configured for different desired networking services by programming programmable chip 330 and updating matching tables used in pipelines 333, 334. For example, in some embodiments, programmable chip 330 is programmed to perform a load balancing under the control of service runtime API 415 to share traffic among multiple servers in the network system.

In addition, programmable chip 330 can also be programmed to perform a security application under the control of service runtime API 415. For example, the security application may include an intrusion detection system (IDS), an intrusion prevention system (IPS), a distributed denial-of-service (DDoS) attack protection, a URL filtering, a web application firewall (WAF), or any combination thereof.

Furthermore, programmable chip 330 can further be programmed to perform a gateway application in L4-L7 under the control of service runtime API 415. The gateway application may include a virtual private cloud gateway (XGW), a network address translation (NAT) gateway, a virtual private network (VPN) gateway, a public network gateway, a gateway line, a routing, or any combination thereof. In some embodiments, programmable chip 330 can be programmed to perform two or more L4-L7 networking services at the same time with a single pipeline or multiple pipelines. It is noted that, though various L4-L7 networking service(s) are mentioned above as examples, the present disclosure is not limited thereto. Those skilled in the art can define and develop various applications using the service model description language to provide corresponding service models to be complied for generating service runtime APIs and programming programmable chip 330.

In some embodiments, whether the packet is a target to be processed by the L4-L7 networking service can be determined by various characteristics when the packet is processed in ingress pipelines IN11, IN12 in pipelines 331, 332. For example, for a load balancer, a packet with a destination IP belonging to one of virtual service IPs (VIPs) can be defined as the target to be processed by the load balancer. Thus, traffic manager 335 can forward the target to corresponding pipeline to perform the load balancing function.

In view of above, ingress pipelines IN11, IN12 and egress pipelines E11. E12 in pipelines 331, 332 provide the switching functions at L2 or L3, while ingress pipelines IN21, IN22 and egress pipelines E21. E22 in pipelines 333, 334 provide the extended networking service(s) in L4-L7 in a service chain of the switching pipeline(s). This folded pipeline structure, by serializing pipelines 331, 332 and pipelines 333, 334, provides additional stage resources available for customized services, and save pipeline resources in programmable chip 330. In addition, host CPU 312 can be used to process the L4-L7 traffic that requires a complicated control logic, since NIC 320 provides a high bandwidth channel to allow traffic to be processed by host CPU 312. Since the platform-dependent code for providing the extended networking service(s) in L4-L7 is hooked in the pipeline framework described above, the interference between fixed switching functions and extended networking service(s) can be avoided.

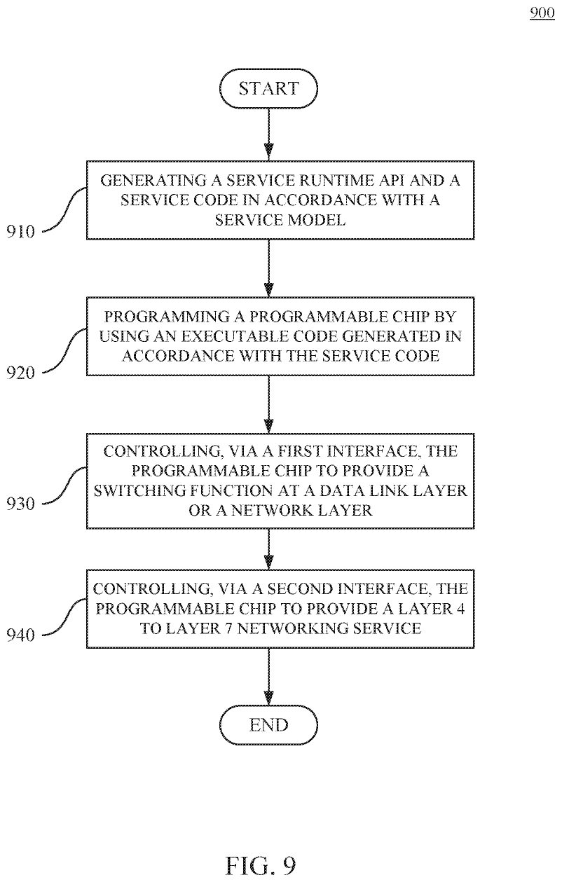

FIG. 9 is a flow diagram of an exemplary method 900 for controlling data transmission in network system 100, consistent with embodiments of the present disclosure. For example, method 900 can be performed or implemented by a network appliance (e.g., network appliance 300 having host CPU 312 and programmable chip 330 in FIG. 2). As shown in FIG. 9, in some embodiments, method 900 includes steps 910-940, which will be discussed in the following paragraphs.

In step 910, a service model compiler (e.g., service model compiler 520 in FIG. 5) generates a service runtime API (e.g., service runtime API 530 in FIG. 5), as the second interface, and a service code (e.g., service code 540 in FIG. 5) in accordance with a service model (e.g., service model 510 in FIG. 5). In some embodiments, step 910 includes identifying programmable chip 330, and in response to an identification of programmable chip 330, compiling service model 510 by service model compiler 520 to generate service runtime API 530 and service code 540. Each of the generated service runtime API 530 and service code 540 are platform dependent and corresponding to programmable chip 330 to support the hardware platform of programmable chip 330.

In step 920, a network appliance (e.g., network appliance 300 in FIG. 5) programs a programmable chip (e.g., programmable chip 330 in FIG. 5) using an executable code (e.g., executable code 570 in FIG. 5) generated in accordance with the service code. For example, in embodiments shown in FIG. 5, platform-dependent compiler 560 compiles service code 540 with fixed function code 550 provided in NOS built on SAI 414, and generates the executable code 570 in accordance with service code 540 and fixed function code 550.

More particularly, in step 920, by loading the executable code, network appliance 300 can program programmable chip 330 using the executable code to configure a first pipeline (e.g., pipelines 331, 332 in FIG. 6 and FIG. 8) to provide the switching function at the data link layer or the network layer, and to configure a second pipeline (e.g., pipelines 333, 334 in FIG. 6 and FIG. 8) to provide the L4-L7 networking service.

In step 930, a host system (e.g., host system 400 in FIG. 5) controls, via a first interface (e.g., SAI 414 in FIG. 5), the programmable chip to provide a switching function at a data link layer or a network layer. In some embodiments, the first interface can be a hardware abstraction layer.

In step 940, the host system controls, via a second interface (e.g., service runtime API 415 in FIG. 5), the programmable chip to provide a L4-L7 networking service. In some embodiments, step 940 includes performing a load balancing under the control of the second interface to share traffic among servers. In some embodiments, step 940 includes performing a security application, or a gateway application under the control of the second interface. The security application may include IDS, IPS, DDoS attack protection, URL filtering, WAF, any other network security services, or any combination thereof. The gateway application may include XGW, NAT gateway, VPN gateway, a public network gateway, a gateway line, a routing, any other network gateway services, or any combination thereof.

More particularly, in steps 930 and 940, the programmable chip receives a packet from an input port of network appliance 300 into the first pipeline. Then, the programmable chip processes the packet in the first pipeline (e.g., pipelines 331, 332 in FIG. 6 and FIG. 8) and determine whether the packet is a target to be processed by the L4-L7 networking service. In response to a determination that the packet is a packet (e.g., packet P1 in FIG. 8) to be processed without the L4-L7 networking service, a traffic manager (e.g., traffic manager 335 in FIG. 6 and FIG. 8) forwards the processed packet (e.g., packet P1′ in FIG. 8) to an output port of network appliance 300. Thus, host system 400 can, via SAI 414, control programmable chip 330 to provide the switching function at the data link layer or the network layer.

On the other hand, in response to a determination that the packet is the target (e.g., packet P2 in FIG. 8) to be processed by the L4-L7 networking service, the traffic manager forwards the processed packet (e.g., packet P2′ in FIG. 8) to the second pipeline (e.g., pipelines 333, 334 in FIG. 6 and FIG. 8) to further process the packet in the second pipeline. After processing the packet in the second pipeline, the traffic manager again forwards the processed packet (e.g., packet P2″ in FIG. 8) from the second pipeline to the first pipeline and forwards the processed packet to the output port of network appliance 300. Thus, host system 400 can, via service runtime API 415, control programmable chip 330 to provide the L4-L7 networking service.

Therefore, by the above operations in steps 910-940, host system 400 can provide a framework running both the fixed switching functions at L2 or L3, and the extended networking service(s) in L4-L7.

In view of above, as proposed in various embodiments of the present disclosure, an open interface is provided for user to develop various networking services or applications running on a programmable chip and/or a host CPU in an apparatus for controlling data transmission in a network system. The programmable chip can be programmed to perform the network services or applications using pipeline(s) which are not directly assigned for ports of the apparatus, while pipeline(s) assigned to the ports perform the fixed switching functions. By decoupling the fixed switching functions and the extended networking service(s) or applications, the apparatus is able to provide the extended networking service(s) in L4-L7 under the control of the second interface, without interfering the fixed switching functions provided by an open source software (e.g., SONiC) on the first interface, such as a hardware abstraction layer (e.g., a Switch Abstraction Interface). Further, by generating platform dependent service runtime API and platform dependent service code for programming, this combined service framework can be realized in various hardware platforms supplied by different network hardware vendors, which provides flexibilities in providing network services or applications in data centers, edge computing systems, and/or cloud computing systems.

By combining a network operating system and load balancing or other L4-L7 network services in the switching apparatus, operation cost in various applications, such as the content delivery network (CDN) or the edge computing, can be reduced without compromising the switching performance. Further, operators can manage and monitor the network via various operations and maintenance tools provided in the network operating system, which improves the efficiency for maintaining the network system.

The various example embodiments described herein are described in the general context of method steps or processes, which may be implemented in one aspect by a computer program product, embodied in a transitory or a non-transitory computer-readable medium, including computer-executable instructions, such as program code, executed by computers in networked environments. Common forms of non-transitory media include, for example, a floppy disk, a flexible disk, hard disk, solid state drive, magnetic tape, or any other magnetic data storage medium, a CD-ROM, any other optical data storage medium, a RAM, a PROM, and EPROM, a FLASH-EPROM or any other flash memory, NVRAM, a cache, a register, any other memory chip or cartridge, and networked versions of the same. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. An apparatus for controlling data transmission in a network system, comprising:
a programmable chip configured to forward data in the network system;
one or more storage devices configured to store a set of instructions; and
one or more processors configured to execute the set of instructions to cause the apparatus to:
control, via a first interface, the programmable chip to provide a switching function at a data link layer or a network layer; and
control, via a second interface, the programmable chip to provide a layer 4 to layer 7 networking service.

2. The apparatus of claim 1, wherein the programmable chip comprises:
a first pipeline, the first pipeline further comprising:
an ingress port configured to receive data from a corresponding port of the apparatus; and
an egress port configured to forward data to a corresponding port of the apparatus; and
a second pipeline, the second pipeline further comprising:
an ingress port and an egress port, the ingress port of the second pipeline being configured to receive data from the egress port of the second pipeline.

3. The apparatus of claim 2, wherein the one or more processors are configured to execute the set of instructions to cause the apparatus to:
generate a service runtime application programming interface (API), as the second interface, and a service code in accordance with a service model; and
program the programmable chip by using an executable code compiled in accordance with the service code.

4. The apparatus of claim 3, wherein the one or more processors are configured to execute the set of instructions to cause the apparatus to program the programmable chip by using the executable code to:
configure the first pipeline to provide the switching function at the data link layer or the network layer.

5. The apparatus of claim 3, wherein the one or more processors are configured to execute the set of instructions to cause the apparatus to program the programmable chip by using the executable code to:
configure the second pipeline to provide the layer 4 to layer 7 networking service.

6. The apparatus of claim 3, wherein the one or more processors are configured to execute the set of instructions to cause the apparatus to program the programmable chip to:
receive a packet from an input port of the ports;
process the packet in the first pipeline and determine whether the packet is a target to be processed by the layer 4 to layer 7 networking service; and
in response to a determination that the packet is a packet to be processed without the layer 4 to layer 7 networking service, forward the processed packet to an output port of the ports.

7. The apparatus of claim 6, wherein the one or more processors are configured to execute the set of instructions to cause the apparatus to program the programmable chip to:
in response to a determination that the packet is the target to be processed by the layer 4 to layer 7 networking service, forward the packet to the second pipeline;
process the packet in the second pipeline;
forward the processed packet from the second pipeline to the first pipeline; and
forward the processed packet to the output port of the ports.

8. The apparatus of claim 3, wherein the one or more processors are configured to execute the set of instructions to cause the apparatus to generate the service runtime API, as the second interface, and the service code by:
identifying the programmable chip; and
in response to an identification of the programmable chip, compiling the service model via a service model compiler to generate the service runtime API and the service code, each of the generated service runtime API and service code being platform dependent and corresponding to the programmable chip.

9. The apparatus of claim 1, wherein the one or more processors are configured to execute the set of instructions to cause the apparatus to:
control, via the second interface, the programmable chip to perform a load balancing to share traffic among a plurality of servers.

10. The apparatus of claim 1, wherein the one or more processors are configured to execute the set of instructions to cause the apparatus to:
control, via the second interface, the programmable chip to perform a security application, wherein the security application comprises an intrusion detection system (IDS), an intrusion prevention system (IPS), a distributed denial-of-service (DDoS) attack protection, a URL filtering, a web application firewall (WAF), or any combination thereof.

11. The apparatus of claim 1, wherein the one or more processors are configured to execute the set of instructions to cause the apparatus to:
control, via the second interface, the programmable chip to perform a gateway application, wherein the gateway application comprises a virtual private cloud gateway (XGW), a network address translation (NAT) gateway, a virtual private network (VPN) gateway, a public network gateway, a gateway line, a routing, or any combination thereof.

12. The apparatus of claim 1, further comprising:
a network interface controller configured to transmit data between the programmable chip and the one or more processors.

13. A method for controlling data transmission in a network system, comprising:
controlling, via a first interface, a programmable chip to provide a switching function at a data link layer or a network layer; and
controlling, via a second interface, the programmable chip to provide a layer 4 to layer 7 networking service.

14. The method for controlling data transmission in the network system of claim 13, further comprising:
generating a service runtime application programming interface (API), as the second interface, and a service code in accordance with a service model; and
programming the programmable chip by using an executable code generated in accordance with the service code.

15. The method for controlling data transmission in the network system of claim 14, wherein programming the programmable chip using the executable code comprises:
configuring a first pipeline to provide the switching function at the data link layer or the network layer; and
configuring a second pipeline to provide the layer 4 to layer 7 networking service.

16. The method for controlling data transmission in the network system of claim 15, further comprising:
receiving a packet from an input port into the first pipeline;
processing the packet in the first pipeline and determining whether the packet is a target to be processed by the layer 4 to layer 7 networking service; and
in response to a determination that the packet is a packet to be processed without the layer 4 to layer 7 networking service, forward the processed packet to an output port.

17. The method for controlling data transmission in the network system of claim 16, further comprising:
in response to a determination that the packet is the target to be processed by the layer 4 to layer 7 networking service, forwarding the packet to the second pipeline;
processing the packet in the second pipeline;
forwarding the processed packet from the second pipeline to the first pipeline; and
forwarding the processed packet to the output port.

18. The method for controlling data transmission in the network system of claim 14, wherein generating the service runtime API, as the second interface, and the service code in accordance with the service model comprises:
identifying the programmable chip; and
in response to an identification of the programmable chip, compiling the service model via a service model compiler to generate the service runtime API and the service code, each of the generated service runtime API and service code being platform dependent and corresponding to the programmable chip.

19. The method for controlling data transmission in the network system of claim 13, wherein controlling the programmable chip to provide the layer 4 to layer 7 networking service comprises:
controlling, via the second interface, the programmable chip to perform a load balancing to share traffic among a plurality of servers.

20-21. (canceled)

22. A non-transitory computer-readable medium that stores a set of instructions that is executable by one or more processors of an apparatus to cause the apparatus to perform a method for controlling data transmission in a network system, the method for controlling data transmission in the network system comprising:
controlling, via a first interface, a programmable chip to provide a switching function at a data link layer or a network layer; and
controlling, via a second interface, the programmable chip to provide a layer 4 to layer 7 networking service.

23. The non-transitory computer-readable medium of claim 22, wherein the set of instructions that is executable by the one or more processors of the apparatus causes the apparatus to further perform:
configuring a first pipeline to provide the switching function at the data link layer or the network layer; and
configuring a second pipeline to provide the layer 4 to layer 7 networking service.

24. The non-transitory computer-readable medium of claim 23, wherein the set of instructions that is executable by the one or more processors of the apparatus causes the apparatus to further perform:
receiving a packet from an input port into the first pipeline;
processing the packet in the first pipeline and determining whether the packet is a target to be processed by the layer 4 to layer 7 networking service; and
in response to a determination that the packet is a packet to be processed without the layer 4 to layer 7 networking service, forward the processed packet to an output port.

25. The non-transitory computer-readable medium of claim 24, wherein the set of instructions that is executable by the one or more processors of the apparatus causes the apparatus to further perform:
in response to a determination that the packet is the target to be processed by the layer 4 to layer 7 networking service, forwarding the packet to the second pipeline;
processing the packet in the second pipeline;
forwarding the processed packet from the second pipeline to the first pipeline; and
forwarding the processed packet to the output port.

26. The non-transitory computer-readable medium of claim 22, wherein the set of instructions that is executable by the one or more processors of the apparatus causes the apparatus to further perform:
controlling, via the second interface, the programmable chip to perform a load balancing to share traffic among a plurality of servers.

27. The non-transitory computer-readable medium of claim 22, wherein the set of instructions that is executable by the one or more processors of the apparatus causes the apparatus to further perform:
control, via the second interface, the programmable chip to perform a security application, wherein the security application comprises an intrusion detection system (IDS), an intrusion prevention system (IPS), a distributed denial-of-service (DDoS) attack protection, a URL filtering, a web application firewall (WAF), or any combination thereof.

28-36. (canceled)
